(19) United States
(12) Patent Application Publication
(10) Pub. No.: US 2026/0213955 A1
(43) Pub. Date: Jul. 23, 2026

(54) Hardware-Anchored Universal AI Governance Fabric with Heterogeneous TEE Orchestration, Cross-Domain Federation, and Multi-Jurisdictional Regulatory Verification

(71) Applicant: George William Bickerstaff, III, Greenwich, CT (US)

(72) Inventor: George William Bickerstaff, III, Greenwich, CT (US)

(21) Appl. No.: 19/561,478

(22) Filed: Mar. 9, 2026

(51) Int. Cl. H04L 9/32; H04L 9/00; H04L 9/08

(52) U.S. Cl. CPC H04L 9/3247; H04L 9/0852; H04L 9/0877; H04L 9/3213; H04L 9/3218; H04L 9/3239; H04L 9/3263; H04L 9/50

(57) ABSTRACT

Prior AI governance systems operate as isolated domain silos and cannot share hardware-attested evidence across domains, generate simultaneous multi-framework regulatory proofs, or allow regulators to independently verify compliance. The present invention introduces a Universal AI Governance Fabric, a horizontal platform that federates domain-specific Trusted Execution Environment (TEE) systems under a single cryptographically unified trust state anchored to silicon root-of-trust keys inaccessible to software. A heterogeneous TEE orchestration layer verifies attestations across multiple enclave technologies including Intel SGX, AMD SEV-SNP, Intel TDX, ARM TrustZone, and major confidential computing environments. When a threshold violation occurs, an atomic cross-domain transition orchestrator simultaneously destroys baseline session keys, increments hardware monotonic counters, and activates IOMMU isolation across participating systems. A Unified Regulatory Verification Engine generates jurisdiction-specific evidence packs for major regulatory frameworks from a single zero-knowledge proof computation, enabling independent regulator verification and providing a secure, cross-domain AI governance infrastructure.

### CROSS-REFERENCE TO RELATED APPLICATIONS

This application claims the benefit of U.S. Provisional Application No. 63/123,456, filed Jul. 15, 2025, the entire disclosure of which is incorporated by reference. This application is also a continuation-in-part of all 99 U.S. patent applications filed under USPTO Customer No. 212041 between August 2025 and Mar. 9, 2026, and specifically incorporates by reference the TEE architectures, silicon root-of-trust mechanisms, atomic state-transition machines, quantum-resistant provenance ledgers, zero-knowledge proof generators, and regulatory verification engines disclosed in application Ser. No. 19/560,079 (Patent 98: TEE-Attested Federated Stem Cell Therapy Orchestrator), application Ser. No. 19/561,428 (Patent 99: Hardware-Anchored DAO Governance Engine with Quorum Verification and Regulatory Compliance), and the Basel IV hardware-anchored suite, capital markets layer, and horizontal TEE infrastructure claims of the companion applications filed under the same customer number. The present application provides the unifying horizontal governance layer that federates all prior portfolio applications into a single, cryptographically verifiable, regulator-mandatable AI governance fabric.

### FIELD OF THE INVENTION

The present invention relates to Trusted Execution Environments applied to cross-domain artificial intelligence governance at enterprise and multi-enterprise scale. More particularly, it provides a hardware-anchored Universal AI Governance Fabric that federates previously siloed TEE-based AI systems—spanning influence and trust scoring, clinical AI and healthcare orchestration, autonomous agent governance, financial compliance, decentralized governance, and quantum-safe frontier technology—under a single cryptographically unified trust state. The Fabric enforces consistent, hardware-irreversible compliance and provenance across all six commercial domains of the Bickerstaff portfolio simultaneously, through a Cross-Cluster Attestation Bridge, a Heterogeneous TEE Orchestration Layer, a Unified Regulatory Verification Engine producing simultaneous multi-jurisdictional zero-knowledge proof evidence packs, hardware-enforced atomic cross-domain state transitions, a Federated Provenance Ledger Aggregator, a Regulatory Verification Network with independent regulator-operated nodes, an Enterprise Trust Federation Registry, post-quantum trust propagation, and an Autonomous Agent Swarm Governance Coordinator—all anchored to silicon-level hardware roots of trust that no software process, privileged operator, voting majority, or cloud provider management plane can bypass or modify.

### BACKGROUND OF THE INVENTION

The 99-application Bickerstaff Trust portfolio demonstrates that domain-specific TEE-anchored AI governance is technically feasible and commercially valuable across six commercial domains: Influence and Trust, Clinical AI and Healthcare, AI Governance and Autonomous Agents, Financial AI and Capital Markets, Decentralized Governance, and Quantum-Safe and Frontier Technology. Each domain operates a TEE-resident governance engine that enforces compliance through hardware-anchored attestation, atomic state transitions, quantum-resistant provenance ledgers, and zero-knowledge proof regulatory evidence. However, each domain currently operates as an independent silo. A stem-cell safety orchestrator cannot share hardware-attested safety evidence with a Basel IV capital compliance engine without re-establishing trust from scratch. An influence-scoring engine cannot feed cryptographically verified trust signals into an autonomous agent coalition without duplicating attestation infrastructure. No single platform produces simultaneous regulatory evidence across all major frameworks from one federated computation—forcing regulators, enterprises, and investors to manage fragmented compliance burdens, duplicated attestation stacks, and unresolvable provenance gaps whenever AI decisions cross domain boundaries.

Cross-domain AI decisions are not hypothetical edge cases—they are the central operational reality of modern enterprise AI deployment. A financial AI system allocating capital to regenerative medicine trials must simultaneously satisfy Basel IV capital adequacy requirements, CMS value-based care evidence standards, and EMA adaptive licensing criteria. An influence-weighted autonomous agent coalition executing clinical workflows must simultaneously satisfy EU AI Act high-risk system obligations, FDA software-as-medical-device requirements, and SEC supply-chain disclosure rules. No existing platform provides the hardware-anchored horizontal layer that makes these cross-domain compliance operations simultaneously verifiable by independent regulators from a single computation.

The fundamental deficiency in all existing federated AI governance systems is the absence of silicon-level hardware roots of trust as the foundation for cross-domain attestation. Existing federated-learning frameworks including Flower and PySyft rely on software attestation mechanisms that reside in memory accessible to privileged processes, making them vulnerable to key copying before destruction completes. Multi-party TEE systems including Secret Network and Oasis Sapphire provide enclave isolation for individual computations but lack cross-cluster attestation bridging, heterogeneous TEE vendor orchestration, unified regulatory verification engines producing simultaneous multi-jurisdictional evidence packs, hardware-enforced atomic cross-domain state transitions in which all participating instances simultaneously execute the four-step transition, and post-quantum trust propagation that survives domain boundaries. Enterprise middleware platforms including IBM OpenPages, MetricStream, and SAP GRC operate entirely in software and cannot provide the cryptographic irreversibility, hardware-rooted temporal ordering, or independent regulator verification that the present invention supplies.

A second structural deficiency in all existing systems is the absence of heterogeneous TEE orchestration across multiple hardware vendors and cloud providers simultaneously. Systems that rely on a single TEE vendor or a single cloud provider create a single point of compromise: a fault in Intel SGX firmware, a cloud provider management plane vulnerability, or a supply-chain attack on a specific hardware vendor can compromise the entire governance fabric. No existing multi-domain AI governance system provides simultaneous attestation verification, cross-verification, and quorum agreement across Intel SGX, AMD SEV-SNP, Intel TDX, ARM TrustZone, AWS Nitro Enclaves, Azure Confidential Virtual Machines, and Google Confidential Computing in a unified governance fabric.

A third structural deficiency is the absence of independent regulatory verification infrastructure. Every existing compliance evidence system in financial services, healthcare, and enterprise AI produces evidence from within the governed system and submits it to regulators for review—the regulated entity grades its own compliance. No existing system enables regulators to operate independent verification nodes that autonomously validate the hardware attestation, monotonic counter sequences, and provenance ledger commitments underlying each compliance evidence package, transforming compliance from self-certification into third-party-verified cryptographic fact.

A fourth deficiency is the absence of atomic cross-domain state transitions. When a threshold violation occurs in one domain, existing systems either propagate the violation through software messaging—vulnerable to message dropping, replay, and reordering—or require manual cross-domain coordination. No existing system executes the complete four-step atomic transition (state-transition record incorporation into all bridged attestation user-data fields, simultaneous baseline session key destruction and post-quantum re-keying, hardware monotonic counter increment across all participating instances, and IOMMU-enforced network isolation) simultaneously across all bridged TEE instances as a single atomic operation, making partial or reversible cross-domain transitions physically impossible.

A fifth deficiency is the absence of global multi-enterprise federation. Existing TEE governance systems are designed for deployment within a single enterprise or a single cloud tenancy. No existing system provides the hardware-anchored federation layer that allows independent organizations—a hospital network, an investment bank, a regulatory authority, and a pharmaceutical consortium—to each operate domain-specific TEE instances contributing to a shared governance fabric while maintaining hardware-level isolation of each organization's proprietary data, and while enabling any regulator to independently validate the fabric's compliance evidence against a shared on-chain attestation registry.

Technical Improvement Under 35 U.S.C. § 101. The present invention improves the functioning of distributed AI governance computer systems by introducing silicon-level hardware root-of-trust mechanisms—heterogeneous TEE orchestration across seven distinct hardware architectures, atomic cross-domain key destruction, hardware monotonic counter synchronization, cross-cluster attestation bridging, and post-quantum trust propagation—that are architecturally impossible to achieve through software modifications alone. The technological problem is fragmented, unverifiable, software-bypassable AI governance across domain boundaries. The technological solution is a hardware-anchored horizontal fabric providing cryptographic irreversibility, hardware-rooted temporal ordering, third-party regulatory verification, and privacy-preserving multi-jurisdictional evidence from one computation. As clarified in the August 2025 Kim Memorandum and December 2025 Desjardins guidance, limitations involving hardware-isolated execution, silicon-level key destruction, and cryptographic irreversibility cannot practically be performed in the human mind and integrate any alleged abstract idea into a practical application, satisfying patent-eligibility criteria under Enfish, Alice Step 2A Prong 2, and related authority.

### SUMMARY OF THE INVENTION

The present invention provides a hardware-anchored Universal AI Governance Fabric—referred to herein as the Fabric—that operates as the horizontal trust layer atop all 99 prior portfolio applications. In a first aspect, the invention provides a hardware-anchored system comprising a Silicon Root-of-Trust Anchor Layer, a Heterogeneous TEE Orchestration Layer, a Cross-Cluster Attestation Bridge, an Enterprise Trust Federation Registry, a Unified Regulatory Verification Engine, a Multi-Domain State Synchronization Machine, a Federated Provenance Ledger Aggregator, a Regulatory Verification Network, a Post-Quantum Multi-Domain Attestation Layer, and an Autonomous Agent Swarm Governance Coordinator. In a second aspect, the invention provides a corresponding method. In a third aspect, it provides one or more non-transitory computer-readable media. In a fourth aspect, it provides a multi-enterprise deployment architecture in which independent organizations each operate domain-specific TEE instances contributing to a shared Fabric while maintaining hardware-level isolation of proprietary data.

Five novel architecture elements distinguish the present invention from all prior art, including the 99 prior portfolio applications: (1) a Silicon Root-of-Trust Anchor Layer binding all Fabric attestations to vendor-specific hardware root keys—Intel SGX root provisioning keys, AMD SEV-SNP chip-specific Versioned Chip Endorsement Keys, ARM TrustZone Platform Security Architecture root keys, AWS Nitro Hardware Security Module keys, and TPM 2.0 endorsement keys—providing a silicon-level origin for all attestation chains that no software process can fabricate; (2) a Heterogeneous TEE Orchestration Layer that simultaneously verifies, normalizes, and cross-verifies attestations across all seven supported TEE architectures, preventing any single vendor compromise from affecting fabric-wide governance; (3) a Regulatory Node Architecture in which regulators, designated auditors, and institutional counterparties operate independent verification nodes that autonomously validate evidence packs and issue signed validation receipts, transforming compliance from self-certification into independently verifiable cryptographic fact; (4) a hardware-synchronized Atomic Cross-Domain Transition Mechanism executing the complete four-step state transition simultaneously across all bridged TEE instances as a single atomic operation; and (5) a Global Enterprise Federation Architecture supporting deployment across multiple independent organizations and regulatory jurisdictions while maintaining a unified cryptographic governance state.

The technical effect of the invention arises from all components operating together under a common hardware root of trust. Silicon-level attestation keys make cross-cluster evidence non-forgeable at the origin. Heterogeneous TEE orchestration eliminates single-vendor compromise risk. The on-chain Enterprise Trust Federation Registry prevents counterfeit Fabric deployment. Regulator-operated verification nodes make compliance independently verifiable. Atomic cross-domain transitions make violation cover-up physically impossible. Post-quantum signatures protect the entire evidence chain across multi-decade retention horizons. The Federated Provenance Ledger Aggregator produces a single source of truth for all AI decisions across all domains. The Unified Regulatory Verification Engine produces simultaneous evidence for eight regulatory frameworks from one computation. The Autonomous Agent Swarm Governance Coordinator extends hardware-enforced governance to thousands of specialized AI agents acting as a single trusted organism. No prior system—including the 99 prior portfolio applications individually—teaches or suggests this combination.

### DEFINITIONS

As used herein, the following ten terms are defined in alphabetical order. Plain-language explanations in italics follow each definition and do not limit the scope of the claims.
1. “Atomic Cross-Domain Transition Orchestrator” means the module that executes, upon detection of a threshold violation in any bridged domain confirmed by multi-TEE quorum, a four-step atomic operation simultaneously across all participating TEE instances: incorporating a cross-domain state-transition record into the attestation report user-data field of every bridged instance; atomically destroying all baseline session keys across all instances and deriving post-transition session keys via CRYSTALS-Kyber key derivation from the degraded-state attestations; incrementing hardware monotonic counters in all participating instances; and activating IOMMU-enforced network isolation across all instances, with no partial or reversible intermediate states possible at any software privilege level.

Plain language: When any part of the fabric detects a problem, all parts simultaneously lock down in one hardware-enforced step. There is no way to stop the process halfway or pretend it did not happen.
2. “Autonomous Agent Swarm Governance Coordinator” means the Fabric component that orchestrates coalitions of AI agents spanning two or more domains under a single hardware-anchored governance state, issuing hardware-attested agent authorization tokens from the compliant-state session key of the unified Fabric, revoking authorization across all agents simultaneously when the Multi-Domain State Synchronization Machine executes a cross-domain transition, and recording all agent authorization and revocation events in the Federated Provenance Ledger with monotonic counter values and multi-TEE attestation signatures.

Plain language: Thousands of specialized AI agents—influence scorers, clinical planners, capital allocators, logistics routers—act as one trusted organism, governed by the same hardware rules. If any domain fails, all agent authorizations revoke instantly.
3. “Cross-Cluster Attestation Bridge” means a TEE-resident module executing within enclave-protected memory that receives hardware-signed attestation reports from at least two domain-specific TEE engines, normalizes provider-specific report formats to a unified internal schema, cross-verifies enclave measurements against the Enterprise Trust Federation Registry, verifies hardware monotonic counter consistency across participating instances, and produces a unified trust token carrying attestation signatures from all participating instances, binding cross-domain governance decisions to the hardware root-of-trust elements of every contributing domain TEE.

Plain language: A universal cryptographic translator that binds the identity proof of a stem-cell safety engine and a Basel IV capital engine into one shared token, verifiable by any regulator or counterparty. Neither can forge the other's chip fingerprint.
4. “Enterprise Trust Federation Registry” means a smart contract deployed on at least one blockchain network, or an equivalent permissioned distributed ledger, that stores approved static enclave measurements for every participating domain-specific TEE engine and for the Fabric orchestration layer itself, queried by the Cross-Cluster Attestation Bridge and by all domain governance contracts before accepting cross-cluster trust tokens, wherein registry updates require TEE-attested multi-signature quorum authorization, and wherein tokens produced by engines with non-matching measurements are structurally rejected at the smart contract or distributed ledger level without requiring external policy enforcement.

Plain language: A public list of approved chip fingerprints for every engine in the fabric. A counterfeit or modified engine has a different fingerprint and is automatically rejected by the blockchain before it can contaminate any cross-domain decision.
5. “Federated Provenance Ledger Aggregator” means an append-only SHA-3 Merkle tree executing inside enclave-protected memory that receives domain-specific provenance ledger entries from every participating domain TEE engine, each entry linked to its domain-specific SHA3-256 hash chain, and merges them into a single unified Merkle root commitment signed with post-quantum CRYSTALS-Dilithium or SPHINCS+ signatures, providing a single cryptographically verifiable source of truth for all AI governance decisions across all domains simultaneously, with each entry bound to hardware monotonic counter values and multi-instance attestation signatures.

Plain language: One unforgeable record of every AI decision across every domain. A regulator can verify the entire governance history of a multi-domain AI system from a single Merkle root, without accessing any proprietary model or personal data.
6. “Heterogeneous TEE Orchestration Layer” means the Fabric subsystem that simultaneously enrolls, verifies, normalizes, and cross-verifies attestation reports from TEE instances spanning at least two distinct hardware vendors or cloud providers, including Intel SGX using MRENCLAVE and MRSIGNER measurements, AMD SEV-SNP using Versioned Chip Endorsement Key attestation reports, Intel TDX using TDREPORT structures, ARM TrustZone using Platform Security Architecture attestation, AWS Nitro Enclaves using NSM attestation documents, Azure Confidential Virtual Machines using SEV-SNP VCEK-signed reports, and Google Cloud Confidential Computing using Intel TDX remote attestation, normalizing all formats to a unified internal representation and executing cross-vendor measurement verification before any cross-cluster trust token is generated.

Plain language: Instead of trusting one chip manufacturer, the fabric simultaneously verifies multiple chip fingerprints from Intel, AMD, ARM, AWS, Azure, and Google. A vulnerability in any single vendor's hardware is detected and quarantined before it affects the governance state.
7. “Multi-Domain State Synchronization Machine” means the state machine executing inside the Fabric orchestration TEE that monitors compliance thresholds across all bridged domain engines via the Cross-Cluster Attestation Bridge, detects violations in any domain, triggers quorum verification across all participating instances, and upon confirmed violation executes the Atomic Cross-Domain Transition Orchestrator, maintaining a cryptographic record of the pre-transition and post-transition unified trust states in the Federated Provenance Ledger with monotonic counter values, hardware-signed attestation fields, and Regulatory Verification Network node validation receipts.

Plain language: The brain that watches all domains simultaneously. When any part of the ecosystem detects a compliance problem, this machine ensures every other part responds instantly and in lockstep—not sequentially, not approximately, but simultaneously and atomically.
8. “Regulatory Verification Network” means a distributed network of independent verification nodes operated by regulators, designated auditors, institutional counterparties, or national competent authorities, each node executing software that autonomously validates Fabric evidence packs by: querying the Enterprise Trust Federation Registry to verify enclave measurements of all contributing domain engines; verifying hardware monotonic counter value sequences for temporal consistency across all bridged instances; confirming Federated Provenance Ledger Merkle commitment chains; and verifying post-quantum signatures on all attestation exports, issuing signed validation receipts that are embedded in final compliance evidence packages submitted to regulatory portals.

Plain language: The SEC, FDA, EMA, and Basel IV supervisors each run their own validation software on their own servers. They check the evidence independently. The fabric cannot manipulate what they see. Compliance is verified, not claimed.
9. “Silicon Root-of-Trust Anchor Layer” means the Fabric subsystem that binds all attestation chains to vendor-specific silicon-level root keys that cannot be extracted, copied, or modified by any software process at any privilege level, including the Fabric operator, cloud provider management planes, hypervisors, and operating systems, comprising: Intel SGX root provisioning keys embedded in the Intel Provisioning Certification Service hardware; AMD SEV-SNP Versioned Chip Endorsement Keys burned into the AMD processor during manufacturing; ARM TrustZone Platform Security Architecture root keys embedded in the hardware Root of Trust for Reporting; AWS Nitro Enclave Hardware Security Module root keys; Azure Trusted Platform Module 2.0 endorsement keys; and Google Cloud hardware attestation root keys, with all attestation chain verification performed against the published root certificates of each respective vendor.

Plain language: Every trust claim in the fabric ultimately traces back to a key that was burned into a chip at the factory and cannot be changed by anyone, ever. This is why hardware-anchored attestation is qualitatively different from software attestation: the origin is physically unforgeable.
10. “Unified Regulatory Verification Engine” means the Fabric subsystem that assembles, from a single domain-agnostic zero-knowledge proof computation over a unified arithmetic circuit whose public inputs are attestation report user-data fields, Federated Provenance Ledger Merkle roots, hardware monotonic counter values, and multi-instance quorum confirmation signatures, and whose private inputs include all domain-specific model parameters, patient data, financial positions, and influence scores, simultaneous jurisdiction-specific compliance evidence packages formatted for at least eight regulatory frameworks: SEC Form PF, Form ADV, and Schedule D; CFTC Regulation 4.22 and NFA compliance; MiCA ESMA Articles 68 through 76; Basel IV EBA and BCBS Pillar III disclosure; FDA Software as Medical Device and RMAT designation evidence; CMS value-based care and ACO shared savings documentation; EMA adaptive licensing; and ICH Good Clinical Practice, with evidence package export gated on Regulatory Verification Network node validation receipts from all applicable jurisdiction nodes.

Plain language: One proof, eight regulators, zero extra computation. A single ZKP produced inside the fabric satisfies every major regulatory evidence requirement simultaneously without revealing any model parameters, patient data, or financial positions to any party.

### BRIEF DESCRIPTION OF THE DRAWINGS

The accompanying drawings, incorporated in and constituting a part of this specification, illustrate embodiments of the invention. The drawings comprise five figures, each containing five sub-figures, for a total of thirty drawings. Each sub-figure depicts a distinct component or operational stage of the Universal AI Governance Fabric.

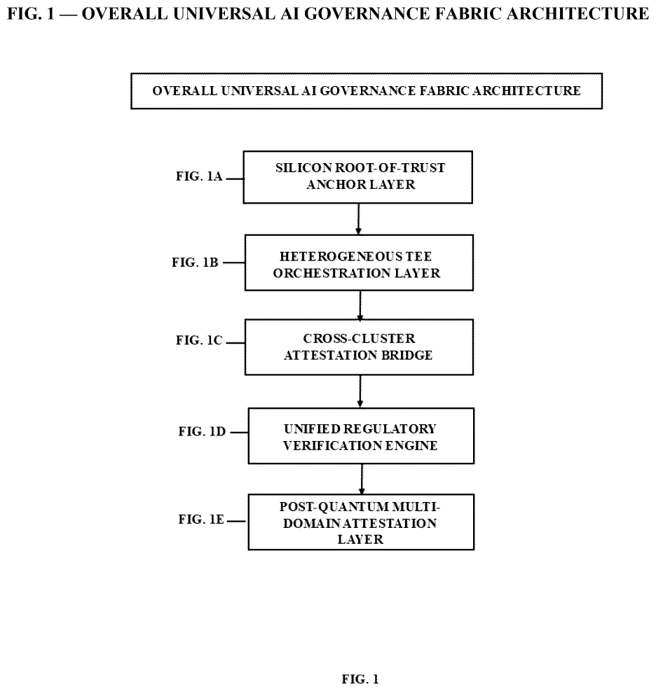

### FIG. 1—Overall Universal AI Governance Fabric Architecture

FIG. 1 is a block diagram illustrating the top-level architecture of the Universal AI Governance Fabric, showing all ten major components and their relationships. The Silicon Root-of-Trust Anchor Layer, Heterogeneous TEE Orchestration Layer, Cross-Cluster Attestation Bridge, Unified Regulatory Verification Engine, Federated Provenance Ledger Aggregator, Multi-Domain State Synchronization Machine, Enterprise Trust Federation Registry, Regulatory Verification Network, Post-Quantum Multi-Domain Attestation Layer, and Autonomous Agent Swarm Governance Coordinator are each shown as distinct components with labeled interconnections. Reference numerals designate corresponding elements consistently across all figures.

### FIG. 1A—Silicon Root-of-Trust Anchor Layer

FIG. 1A is a schematic diagram showing the Silicon Root-of-Trust Anchor Layer binding all Fabric attestation chains to vendor-specific silicon-level root keys, with separate attestation origin paths illustrated for Intel SGX root provisioning keys, AMD SEV-SNP Versioned Chip Endorsement Keys burned into the processor during manufacturing, ARM TrustZone Platform Security Architecture root keys embedded in the hardware Root of Trust for Reporting, AWS Nitro Enclave Hardware Security Module root keys, Azure Trusted Platform Module 2.0 endorsement keys, and Google Cloud hardware attestation root keys.

The attestation chain verification pathway is shown, depicting how each domain-specific TEE instance's attestation report is traced to its vendor-specific silicon root key and verified against the published root certificate of the corresponding hardware vendor before being admitted to the Cross-Cluster Attestation Bridge, ensuring all cross-domain trust relationships originate from physically unforgeable silicon-level key material.

The hardware isolation boundary is depicted, showing that all silicon root keys reside in manufacturer-embedded hardware that cannot be extracted, copied, or modified by any software process at any privilege level, including Fabric operators, cloud provider management planes, hypervisors, and operating systems, with each root key's inaccessibility arising from physical manufacturing properties rather than software access controls.

### FIG. 1B—Heterogeneous Tee Orchestration Layer

FIG. 1B is a schematic diagram illustrating the Heterogeneous TEE Orchestration Layer simultaneously enrolling, verifying, and normalizing attestation reports from TEE instances spanning Intel SGX, AMD SEV-SNP, Intel TDX, ARM TrustZone, AWS Nitro Enclaves, Azure Confidential Virtual Machines, and Google Cloud Confidential Computing, with provider-specific measurement fields labeled for each architecture: MRENCLAVE and MRSIGNER for Intel SGX, VCEK-signed SEV_SNP_REPORT for AMD, TDREPORT for Intel TDX, PSA attestation tokens for ARM, NSM attestation documents for AWS Nitro, and equivalent structures for Azure and Google.

The cross-vendor measurement verification pathway is shown, in which each participating instance's enclave measurement is verified against the Enterprise Trust Federation Registry and cross-verified with measurements from all other participating instances across different hardware vendors, with the quorum agreement mechanism depicted as requiring cryptographic consensus across a threshold of multi-vendor instances before any cross-cluster trust token is generated.

The single-vendor compromise isolation mechanism is depicted, showing that a firmware vulnerability, supply-chain attack, or management plane compromise affecting one hardware vendor is detected during cross-vendor cross-verification—because the compromised instance produces a divergent attestation measurement—and isolated before it propagates to the governance state, with the remaining multi-vendor quorum continuing to operate the Fabric.

### FIG. 1C—Cross-Cluster Attestation Bridge

FIG. 1C is a schematic diagram of the Cross-Cluster Attestation Bridge receiving hardware-signed attestation reports from domain-specific TEE instances representing the Influence and Trust domain, Clinical AI domain, Financial AI domain, Autonomous Agents domain, Decentralized Governance domain, and Quantum-Safe domain, normalizing each report to a unified internal schema, and producing a single unified trust token carrying attestation signatures from all contributing instances with the Enterprise Trust Federation Registry measurement hash embedded for on-chain verification.

The cross-domain trust binding mechanism is shown, depicting how governance decisions that require evidence from multiple domains—such as a capital allocation requiring both Basel IV financial compliance attestation and FDA clinical safety attestation—receive a unified trust token whose cryptographic validity depends on the simultaneous validity of all contributing domain attestations, making cross-domain compliance non-repudiable from a single token verification.

The registry verification pathway is depicted, showing the Cross-Cluster Attestation Bridge querying the Enterprise Trust Federation Registry on each applicable blockchain network to confirm that all contributing domain TEE instances have enclave measurements matching approved values before issuing any unified trust token, with non-matching measurements resulting in structural rejection without requiring human intervention or external policy enforcement.

### FIG. 1D—Unified Regulatory Verification Engine

FIG. 1D is a schematic diagram of the Unified Regulatory Verification Engine constructing a single domain-agnostic zero-knowledge proof over a unified arithmetic circuit with public inputs comprising attestation report user-data fields from all bridged domain instances, Federated Provenance Ledger Merkle roots, hardware monotonic counter values from all participating instances, and multi-instance quorum confirmation signatures, with private inputs comprising all domain-specific model parameters, patient data, financial positions, and influence scores that are never revealed in proof outputs.

The eight simultaneous jurisdiction-specific evidence pack generation pathways are shown: SEC adapters for Form PF, Form ADV, and Schedule D; CFTC adapters for Regulation 4.22 and NFA compliance; MiCA adapters for ESMA Articles 68 through 76; Basel IV adapters for EBA and BCBS Pillar III; FDA Software as Medical Device and RMAT adapters; CMS value-based care and ACO shared savings adapters; EMA adaptive licensing adapters; and ICH Good Clinical Practice adapters—all operating from one ZKP computation.

The four-condition evidence export gating mechanism is depicted, showing that no jurisdiction-specific evidence pack is released until Regulatory Verification Network node validation receipts are received from nodes corresponding to each applicable jurisdiction, hardware-signed attestation verification is confirmed, quorum agreement is confirmed across all bridged domain instances, and Enterprise Trust Federation Registry measurement verification is confirmed for all contributing engines.

### FIG. 1E—Post-Quantum Multi-Domain Attestation Layer

FIG. 1E is a schematic diagram of the Post-Quantum Multi-Domain Attestation Layer applying CRYSTALS-Dilithium signatures to all attestation report exports and Federated Provenance Ledger Merkle root exports, and CRYSTALS-Kyber key encapsulation to all inter-TEE communications within the Heterogeneous TEE Orchestration Layer and Cross-Cluster Attestation Bridge, providing cryptographic security against quantum computing attacks on the cross-domain attestation pipeline.

Alternative post-quantum algorithm selection is illustrated, showing Falcon as an alternative providing smaller signature sizes for high-throughput cross-domain deployments, and SPHINCS+ as an alternative providing security based exclusively on SHA-3 hash function collision resistance requiring no lattice assumptions and no trusted setup, with algorithm selection configurable per deployment and per jurisdiction.

The multi-decade retention viability property is depicted, showing how post-quantum signatures applied to all Fabric attestation exports, unified trust tokens, and Regulatory Verification Engine evidence packs ensure compliance evidence submitted to SEC, FDA, EMA, and Basel IV supervisory portals remains cryptographically verifiable against quantum computing adversaries across the multi-decade retention periods required by SEC Rule 17a-4,CFTC Regulation 1.31, FDA 21 CFR Part 11, and MiCA governance documentation obligations.

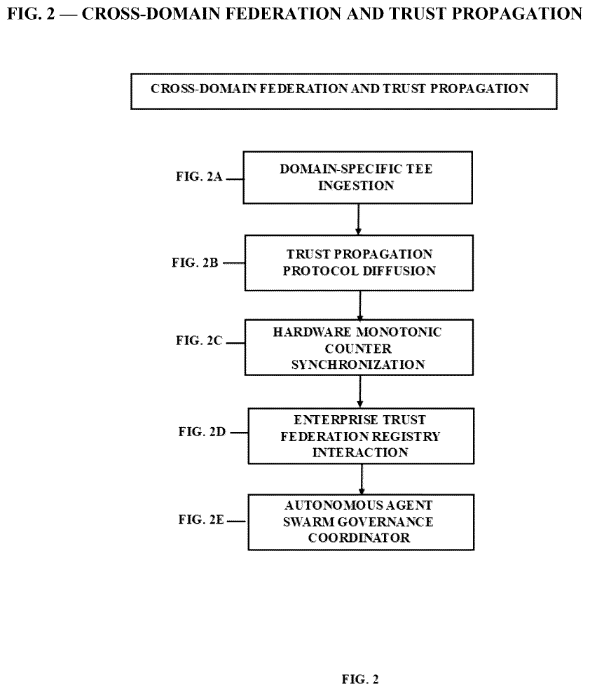

### FIG. 2—Cross-Domain Federation and Trust Propagation

FIG. 2 is a block diagram illustrating the cross-domain federation mechanics, trust propagation protocol, hardware monotonic counter synchronization, Enterprise Trust Federation Registry interaction, and Autonomous Agent Swarm Governance Coordinator operation. The diagram shows the complete federation pipeline from domain-specific TEE ingestion through unified trust state production and agent swarm authorization.

### FIG. 2A—Domain-Specific Tee Ingestion

FIG. 2A is a schematic diagram showing domain-specific TEE engine instances from all six commercial domains—Influence and Trust, Clinical AI and Healthcare, AI Governance and Autonomous Agents, Financial AI and Capital Markets, Decentralized Governance, and Quantum-Safe and Frontier Technology—each generating hardware-signed attestation reports bound to their respective silicon root-of-trust keys and transmitting them to the Heterogeneous TEE Orchestration Layer via attested inter-TEE channels encrypted with CRYSTALS-Kyber key encapsulation.

Provider-specific attestation data carried by each domain TEE instance is illustrated, showing governance event hashes, domain-specific risk threshold status, monotonic counter values, and provenance ledger Merkle roots incorporated into the attestation user-data fields of each domain instance, binding domain-specific compliance states to hardware-signed attestation records that any Regulatory Verification Network node can independently verify.

The cross-domain data isolation boundary is depicted, showing that domain-specific model parameters, patient records, financial positions, voting weight distributions, and influence data never leave their respective domain TEE instances in plaintext—only attestation reports, Merkle commitments, and monotonic counter values flow through the Cross-Cluster Attestation Bridge, preserving proprietary and privacy-protected data within hardware-isolated enclave boundaries across all domain crossings.

### FIG. 2B—Trust Propagation Protocol Diffusion

FIG. 2B is a schematic diagram of the Hardware-Anchored Trust Propagation Protocol diffusing verified trust scores, safety states, and compliance attestations from originating domain TEE instances to receiving domain TEE instances using CRYSTALS-Dilithium-signed trust propagation packets carrying monotonic counter values and originating domain attestation signatures, so that trust earned in one domain is cryptographically verifiable in all receiving domains without re-validation.

The unidirectional trust propagation dependency graph is shown, illustrating how an influence-domain trust score propagated to the clinical domain carries the enclave measurement and monotonic counter of the originating influence engine, enabling the receiving clinical TEE to verify the provenance of the trust signal against the Enterprise Trust Federation Registry without re-running the influence computation or revealing influence model parameters.

The cross-domain trust token composition mechanism is depicted, showing how the Cross-Cluster Attestation Bridge aggregates trust propagation packets from multiple domains into a unified trust token that cryptographically commits to the attested state of every contributing domain engine, enabling a receiving governance contract or regulatory portal to verify multi-domain compliance from a single token verification operation.

### FIG. 2C—Hardware Monotonic Counter Synchronization

FIG. 2C is a schematic diagram illustrating silicon-bound hardware monotonic counter synchronization across all participating domain TEE instances, showing each instance's counter incrementing during cross-domain state transitions and the cross-instance counter verification step confirming all instances have advanced to consistent expected values before any unified trust token is issued.

The cross-vendor counter consistency verification mechanism is shown, depicting how counters from Intel SGX, AMD SEV-SNP, Intel TDX, ARM TrustZone, and AWS Nitro instances are each independently incremented, read, and cross-verified across vendors, with any instance reporting a counter value inconsistent with the synchronized cross-domain transition sequence detected and quarantined by the Multi-Domain State Synchronization Machine.

The tamper-resistant temporal ordering property of synchronized hardware monotonic counters is depicted, showing that Federated Provenance Ledger entries and unified trust tokens embedding synchronized counter values establish an unforgeable cross-domain event sequence verifiable by any Regulatory Verification Network node, preventing reordering, replay, or rollback of cross-domain governance events at any software privilege level.

### FIG. 2D—Enterprise Trust Federation Registry Interaction

FIG. 2D is a schematic diagram of the Enterprise Trust Federation Registry smart contract deployed on multiple blockchain networks—Ethereum mainnet, Hyperledger Fabric, and equivalent permissioned ledgers—storing approved enclave measurements for every domain-specific TEE engine and for the Fabric orchestration layer, with the Cross-Cluster Attestation Bridge querying the registry on each network before issuing unified trust tokens to governance contracts on that network.

The multi-organization registry participation model is shown, illustrating how independent participating organizations—a hospital network, an investment bank, a pharmaceutical consortium, and a regulatory authority—each maintain their own approved measurement entries in the shared registry through TEE-attested multi-signature update transactions requiring quorum authorization from their own TEE instances, enabling cross-organization trust verification without requiring any organization to reveal proprietary model details.

The counterfeit Fabric rejection mechanism is depicted, showing that any organization's governance contracts—on any supported blockchain—structurally reject unified trust tokens from Fabric instances whose enclave measurements do not appear in the shared registry, preventing counterfeit or modified Fabric deployments from contaminating cross-organizational governance decisions regardless of how convincing their proof outputs appear.

### FIG. 2E—Autonomous Agent Swarm Governance Coordinator

FIG. 2E is a schematic diagram of the Autonomous Agent Swarm Governance Coordinator issuing hardware-attested agent authorization tokens derived from the unified Fabric compliant-state session key to AI agent instances spanning the Influence and Trust domain, Clinical AI domain, Financial AI domain, and Autonomous Agents domain, enabling cross-domain agent coalitions to act under a single hardware-anchored governance state.

The simultaneous agent authorization revocation mechanism is shown, depicting how the Swarm Coordinator revokes all outstanding agent authorization tokens across all domains simultaneously when the Multi-Domain State Synchronization Machine executes a cross-domain transition, by destroying the unified compliant-state session key from which all agent tokens are derived, making continued agent operation in the post-transition state computationally infeasible without new authorization from a post-transition session key.

Agent authorization and revocation event recording in the Federated Provenance Ledger is depicted, showing each authorization token issuance and revocation recorded with the issuing Swarm Coordinator instance's attestation signature, the unified trust token commitment, and the synchronized hardware monotonic counter value, enabling auditors and regulators to trace every cross-domain agent action to its authorizing governance state through the unified provenance record.

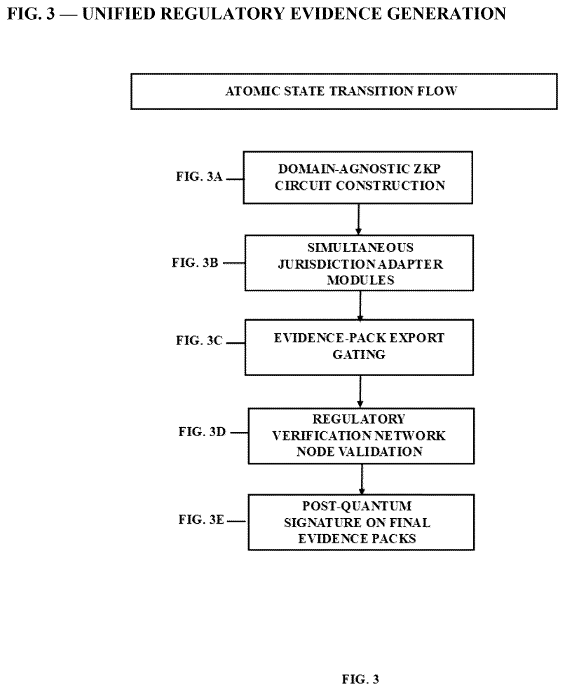

### FIG. 3—Unified Regulatory Evidence Generation

FIG. 3 is a block diagram illustrating the domain-agnostic ZKP circuit construction, simultaneous jurisdiction adapter modules, evidence-pack export gating, Regulatory Verification Network node validation, and post-quantum signature pipeline. The diagram shows the complete evidence generation pathway from unified arithmetic circuit input through multi-jurisdiction regulatory portal submission, with all gating conditions depicted as decision points.

### FIG. 3A—Domain-Agnostic ZKP Circuit Construction

FIG. 3A is a schematic diagram of the domain-agnostic arithmetic circuit construction encoding public inputs from all bridged domain instances—hardware-signed attestation user-data fields, Federated Provenance Ledger Merkle roots computed with SHA3-512, synchronized hardware monotonic counter values, and multi-instance quorum confirmation signatures—into a single unified circuit whose validity simultaneously demonstrates compliance across all contributing domains without requiring separate proof constructions per domain.

The private input isolation architecture is shown, depicting domain-specific model parameters, patient records, financial positions, voting weight distributions, influence scores, and all other proprietary or privacy-protected data as private circuit inputs that are cryptographically committed to the circuit without being revealed in proof outputs, enabling any verifier to confirm that inputs satisfying the compliance circuit exist without seeing what those inputs are.

The structural dependency of unified proof instantiation on post-transition session keys from all contributing domain instances is illustrated, showing that generating a valid unified proof before all participating instances have completed the four-step atomic transition is computationally infeasible, closing the pre-transition compliance attestation vulnerability present in all prior software-managed ZKP governance systems including systems based on single-domain TEE architectures.

### FIG. 3B—Simultaneous Jurisdiction Adapter Modules

FIG. 3B is a schematic diagram of eight simultaneous jurisdiction-specific adapter modules operating from a single ZKP proof output: the SEC adapter formatting Form PF, Form ADV, and Schedule D electronic submissions; the CFTC adapter formatting Regulation 4.22 and NFA compliance filings; the MiCA adapter formatting ESMA Articles 68 through 76 governance documentation; the Basel IV adapter formatting EBA and BCBS Pillar III disclosures; the FDA adapter formatting Software as Medical Device and RMAT designation evidence packages; the CMS adapter formatting value-based care and ACO shared savings documentation; the EMA adapter formatting adaptive licensing evidence; and the ICH adapter formatting Good Clinical Practice documentation.

The single-computation multi-jurisdiction evidence property is depicted, showing that all eight adapter modules receive their inputs from the same ZKP proof computation and the same Federated Provenance Ledger Merkle commitment—not from eight separate computations—eliminating the regulatory fragmentation burden and potential evidentiary inconsistencies that arise when separate compliance computations are run for each jurisdiction.

The adapter output verification pathway is shown, illustrating how each adapter's jurisdiction-specific evidence pack is signed with the Fabric post-quantum attestation key before transmission to the corresponding Regulatory Verification Network nodes, and how each node validates that the evidence pack was produced from the same underlying ZKP proof and provenance commitment as the packages submitted to other jurisdiction nodes, enabling cross-jurisdiction consistency verification.

### FIG. 3C—Evidence-Pack Export Gating

FIG. 3C is a schematic diagram of the four-condition evidence-pack export gating mechanism, showing the four conditions that must be simultaneously satisfied before any jurisdiction-specific evidence pack is released: hardware-signed attestation verification confirming all contributing domain instances are running approved, unmodified enclave code; cryptographic quorum agreement confirmation across all bridged instances; Enterprise Trust Federation Registry measurement verification for all contributing domain engines; and Regulatory Verification Network node validation receipts from all applicable jurisdiction nodes.

The structural impossibility of evidence pack export before all four conditions are satisfied is depicted, showing that the post-transition session key required to sign and release evidence packs does not exist until the atomic cross-domain transition is complete, that quorum confirmation is a cryptographic precondition for session key derivation, and that Registry verification is embedded in the unified trust token that must be presented to the Unified Regulatory Verification Engine before proof instantiation begins.

The cross-jurisdiction gating dependency is shown, illustrating that evidence packs for all applicable jurisdictions are gated on validation receipts from all applicable Regulatory Verification Network nodes simultaneously—a hospital-bank-regulator deployment submitting evidence to SEC, FDA, EMA, and Basel IV supervisors will not release any jurisdiction's package until all four supervisory nodes have issued validation receipts—creating a coordinated multi-regulator evidence submission event.

### FIG. 3D—Regulatory Verification Network Node Validation

FIG. 3D is a schematic diagram of the Regulatory Verification Network node validation process, showing an SEC-operated node, an FDA-operated node, an EMA-operated node, a Basel IV supervisory node, and additional jurisdiction-specific nodes each independently executing validation software that receives the Fabric evidence pack, queries the Enterprise Trust Federation Registry to verify all contributing domain engine enclave measurements, verifies hardware monotonic counter sequences for temporal consistency, and confirms Federated Provenance Ledger Merkle commitment chains.

The node independence architecture is depicted, showing that each Regulatory Verification Network node operates on infrastructure entirely separate from the governed system and from other nodes, receives only the attestation reports, Merkle commitments, counter values, and ZKP proofs needed for validation without receiving any domain-specific model parameters, patient data, or financial positions, and issues a signed validation receipt to the Unified Regulatory Verification Engine only after all validation checks pass.

The cross-node consistency verification mechanism is shown, illustrating how the Unified Regulatory Verification Engine aggregates signed validation receipts from all applicable Regulatory Verification Network nodes and embeds them in the final evidence packages submitted to regulatory portals, enabling each regulator to verify not only that its own node validated the evidence but that all other applicable regulators'nodes also validated the same underlying Fabric state.

### FIG. 3E—Post-Quantum Signature on Final Evidence Packs

FIG. 3E is a schematic diagram of the post-quantum signature pipeline applied to all final evidence packs before regulatory portal submission, showing CRYSTALS-Dilithium signatures applied to each jurisdiction-specific evidence package, the Federated Provenance Ledger Merkle root, the aggregated Regulatory Verification Network validation receipt bundle, and the unified trust token, providing end-to-end post-quantum signature coverage from silicon root-of-trust origin through final regulatory submission.

The multi-decade retention viability property is depicted, showing that CRYSTALS-Dilithium and SPHINCS+ signatures applied at submission time remain verifiable against NIST Post-Quantum Cryptography standard algorithm attacks across the multi-decade retention periods required by SEC Rule 17a-4 seven-year minimum, FDA 21 CFR Part 11 audit trail requirements, EMA clinical trial record retention obligations, and MiCA governance documentation requirements.

The cross-jurisdiction post-quantum signature consistency verification mechanism is shown, illustrating how all eight jurisdiction-specific evidence packs for a given governance event share a common Fabric post-quantum attestation key signature on the underlying Federated Provenance Ledger Merkle root, enabling any future audit—conducted years or decades after the original governance event—to verify that all eight jurisdiction packages originated from the same fabric computation by verifying one post-quantum signature against the shared Merkle root.

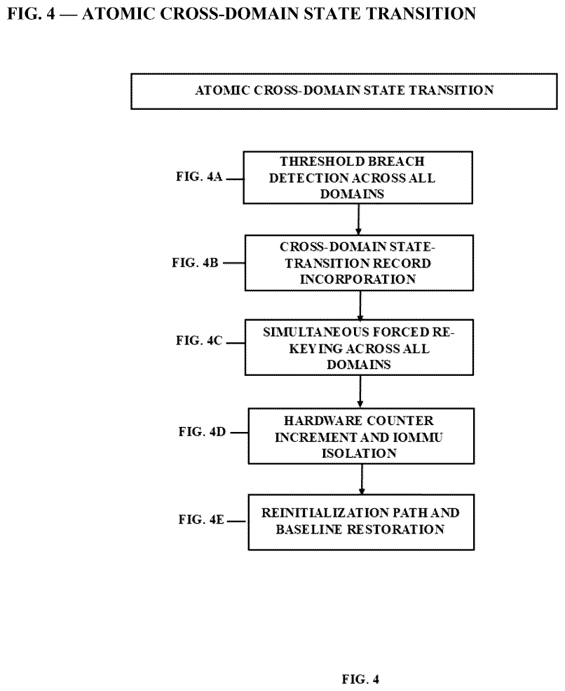

### FIG. 4—Atomic Cross-Domain State Transition

FIG. 4 is a block diagram illustrating the complete atomic four-step cross-domain state transition executed simultaneously across all bridged TEE instances upon detection of a threshold violation in any bridged domain confirmed by multi-TEE quorum. The diagram shows all four steps executing atomically with no partial intermediate states, with cross-references to sub-figures for each step and the reinitialization path.

### FIG. 4A—Threshold Breach Detection Across all Domains

FIG. 4A is a schematic diagram showing the Multi-Domain State Synchronization Machine monitoring compliance threshold status across all six bridged domains via the Cross-Cluster Attestation Bridge, with each domain TEE instance reporting its threshold status through hardware-signed attestation user-data fields carrying domain-specific risk scores, Basel IV ratio values, clinical safety drift indicators, influence manipulation risk scores, and autonomous agent behavioral constraint adherence metrics.

The cross-domain threshold breach escalation mechanism is shown, depicting how a breach in any single domain—such as a Basel IV LCR ratio falling below the sealed threshold, a clinical AI model's safety score drifting below acceptable bounds, or an influence scoring engine detecting coordinated manipulation—triggers the Multi-Domain State Synchronization Machine to initiate quorum verification across all participating instances of all bridged domains before executing the atomic transition.

The quorum confirmation pathway is depicted, showing that the Multi-Domain State Synchronization Machine initiates cross-instance quorum verification specifically for the breach—distributing the breaching domain's attestation report and threshold status to all participating instances across all domains for independent verification—before triggering the Atomic Cross-Domain Transition Orchestrator, ensuring no single-instance false positive can cause a fabric-wide transition.

### FIG. 4B—Cross-Domain State-Transition Record Incorporation

FIG. 4B is a schematic diagram showing a cross-domain state-transition record—comprising a transition flag, high-resolution timestamp, identifier of the breaching domain and specific threshold violated, unified trust token commitment of the pre-transition state, and synchronized counter value—incorporated simultaneously into the attestation report user-data fields of all bridged TEE instances across all six domains, binding the violation to hardware-signed attestation in every participating domain.

Provider-specific user-data field mapping is illustrated for each hardware architecture: the REPORTDATA field in Intel SGX instances, the report_data field in AMD SEV-SNP instances, the user_data field of the TDREPORT in Intel TDX instances, the NSM user data field in AWS Nitro instances, and equivalent fields in ARM TrustZone and Azure instances, showing how the same cross-domain state-transition record is simultaneously bound to each architecture's hardware-signed attestation format.

The resulting attestation reports as independently verifiable evidence of the cross-domain compliance violation are depicted, showing that the hardware signatures binding the cross-domain state-transition record to each instance's enclave measurement and monotonic counter make the violation record unforgeable—not just resistant to tampering but physically impossible to forge without simultaneously compromising the hardware root-of-trust elements of every participating domain TEE across all hardware vendors.

### FIG. 4C—Simultaneous Forced re-Keying Across all Domains

FIG. 4C is a schematic diagram of the simultaneous forced re-keying operation executing across all bridged domain TEE instances, showing baseline session keys atomically zeroed from enclave-protected memory in every instance across every domain—permanently unrecoverable by any process at any privilege level—while post-transition session keys are simultaneously derived from each instance's risk-degraded-state attestation using post-quantum CRYSTALS-Kyber key derivation within each respective TEE.

The unified trust token invalidation consequence is illustrated, showing that baseline session key destruction across all domain instances simultaneously invalidates all outstanding unified trust tokens, agent authorization tokens, and cross-domain execution authorizations derived from any pre-transition session key, making continued cross-domain governance operation under the pre-transition compliance state computationally infeasible regardless of the number of participating instances or the sophistication of the adversary.

The contrast with software-only cross-domain key management is depicted, showing how software key stores accessible to processes capable of copying key material before zeroing completes enable a compromised domain to continue generating valid-looking cross-domain tokens after a transition—and why silicon-level enclave isolation in every participating domain instance simultaneously eliminates this vulnerability by making pre-transition key material physically inaccessible throughout the re-keying window.

### FIG. 4D—Hardware Counter Increment and IOMMU Isolation

FIG. 4D is a schematic diagram showing synchronized hardware monotonic counter increment and IOMMU-enforced network isolation activating simultaneously across all participating domain TEE instances, with counter increment depicted as a silicon-level irreversible operation advancing all instances to the same next expected counter value, and IOMMU isolation depicted as a hardware-level network boundary activation independent of operating system or hypervisor network access controls.

The cross-vendor counter synchronization verification step is shown, in which all instances report their post-increment counter values to the Multi-Domain State Synchronization Machine and cross-verify that all instances have advanced to the expected next value—with any instance reporting an inconsistent counter value detected and quarantined—providing a second independent layer of cross-domain temporal ordering integrity beyond attestation record binding.

The IOMMU isolation maintenance mechanism across the multi-enterprise deployment is depicted, showing that IOMMU isolation activates simultaneously on all participating domain TEE instances across all organizations in the multi-enterprise federation—a hospital network, investment bank, and pharmaceutical consortium each experience simultaneous network isolation on their respective domain instances—and that isolation is maintained until the Multi-Domain State Synchronization Machine confirms threshold restoration across all instances of all organizations through a synchronized quorum re-evaluation.

### FIG. 4E—Reinitialization Path and Baseline Restoration

FIG. 4E is a schematic diagram illustrating the complete Fabric reinitialization process required for reversion to the compliant baseline state, showing all session keys destroyed across all domain TEE instances of all participating organizations, all attestation states reset to initialization conditions, all inter-domain trust propagation channels re-established under new post-initialization session keys, and new static enclave measurements established for all Fabric and domain instances.

The Enterprise Trust Federation Registry update process following reinitialization is shown, depicting new enclave measurements submitted through TEE-attested multi-signature authorization transactions requiring quorum agreement from all reinitializing instances across all participating organizations before updated measurements are accepted by the registry, with a network-wide propagation step ensuring all governance contracts on all supported blockchain networks reflect the updated approved measurements before any cross-domain operations resume.

The business continuity architecture during reinitialization is depicted, showing a warm-standby Fabric instance—pre-initialized with the same approved measurements and sealed compliance thresholds—available for activation after registry update, enabling rapid restoration of cross-domain governance operations following a threshold violation while preserving the cryptographic irreversibility of the original violation record and the complete audit trail in the Federated Provenance Ledger.

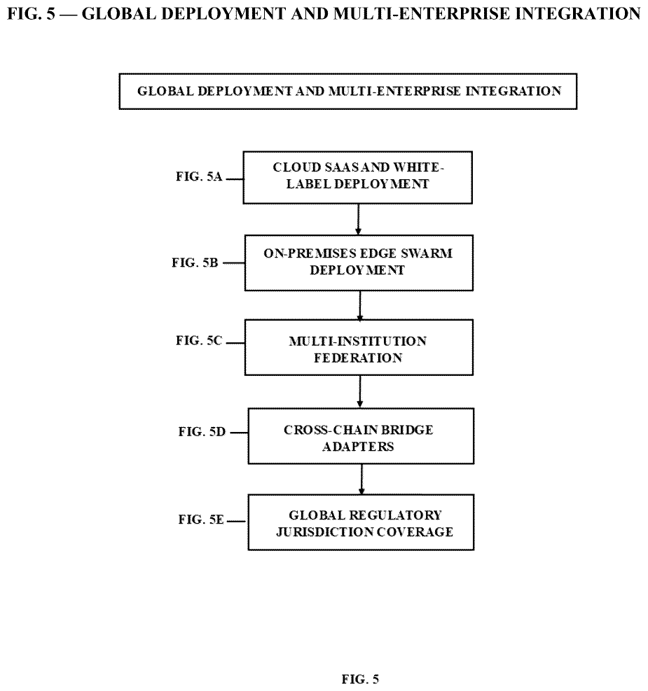

### FIG. 5—Global Deployment and Multi-Enterprise Integration

FIG. 5 is a block diagram illustrating the multi-enterprise federation architecture, on-premises edge swarm deployment, multi-institution integration, cross-chain bridge adapters, and global regulatory jurisdiction coverage of the Universal AI Governance Fabric. The diagram shows the complete global deployment topology from individual domain TEE instances through cross-organizational federation to worldwide regulatory portal integration.

### FIG. 5A—Cloud SaaS and White-Label Deployment

FIG. 5A is a schematic diagram of the cloud SaaS and white-label on-premises deployment architectures for the Fabric, showing cloud SaaS deployment in which the Fabric orchestration layer executes in TEE instances across AWS Nitro Enclaves, Azure Confidential Virtual Machines, and Google Cloud Confidential Computing, with each cloud provider's hardware root-of-trust keys anchoring the corresponding attestation chains verified through the Silicon Root-of-Trust Anchor Layer.

The white-label on-premises deployment architecture is illustrated, showing Fabric instructions distributed on non-transitory computer-readable media installed within enterprise-operated TEE-capable hardware, with each enterprise deployment publishing its enclave measurements to the Enterprise Trust Federation Registry through an attested provisioning channel and initializing with sealed compliance thresholds provided through an attested configuration channel, enabling the same security properties as cloud SaaS in customer-controlled infrastructure.

The hybrid deployment architecture is shown, illustrating a deployment in which a regulated financial institution operates the financial domain TEE on-premises using ARM TrustZone hardware for maximum data sovereignty, a healthcare partner operates the clinical domain TEE in Azure Confidential Virtual Machines for operational flexibility, and the Fabric orchestration layer bridges the two through the Heterogeneous TEE Orchestration Layer, maintaining full attestation chain continuity across the hybrid on-premises and cloud deployment.

### FIG. 5B—On-Premises Edge Swarm Deployment

FIG. 5B is a schematic diagram of on-premises edge swarm deployment in which a large enterprise operates hundreds of AI agent instances across edge computing infrastructure, each agent executing within ARM TrustZone or Intel SGX enclave environments on edge hardware, with the Autonomous Agent Swarm Governance Coordinator issuing hardware-attested agent authorization tokens from the unified Fabric compliant-state session key to each edge agent through attested provisioning channels.

The edge swarm governance lifecycle is illustrated, showing agent authorization token issuance at swarm launch, token renewal at each governance evaluation cycle with updated attestation commitments, and simultaneous token revocation across all edge agents when the Multi-Domain State Synchronization Machine executes a cross-domain transition, with revocation propagated through post-quantum authenticated broadcast messages verifiable against each agent's authorization token.

The edge infrastructure attestation chain is depicted, showing each edge agent's attestation report traced through the Silicon Root-of-Trust Anchor Layer to its hardware manufacturer's root certificate, through the Enterprise Trust Federation Registry for measurement verification, and through the Cross-Cluster Attestation Bridge for inclusion in the unified trust token—providing full cross-domain provenance for every edge agent action from silicon origin through regulatory evidence submission.

### FIG. 5C—Multi-Institution Federation

FIG. 5C is a schematic diagram showing a multi-institution federation comprising a U.S. hospital network operating the clinical domain TEE, a Basel IV-regulated investment bank operating the financial domain TEE, a European pharmaceutical consortium operating a second clinical domain TEE under EMA jurisdiction, and a regulatory authority operating a Regulatory Verification Network node, all federated under the Fabric orchestration layer through the Cross-Cluster Attestation Bridge.

The cross-institution data isolation architecture is depicted, showing that each institution's proprietary data—the hospital's patient records, the bank's trading positions, the consortium's clinical trial data—never leaves the respective institution's domain TEE instance in plaintext, with only hardware-signed attestation reports, Merkle commitments, and monotonic counter values flowing through the Cross-Cluster Attestation Bridge into the unified trust token that binds the cross-institution governance decision.

The regulatory authority node integration is illustrated, showing the regulatory authority's Regulatory Verification Network node independently receiving the Fabric evidence pack, querying the Enterprise Trust Federation Registry to verify enclave measurements of all three institution domain TEE instances, verifying cross-institution monotonic counter sequences, and issuing a signed validation receipt that enables each institution to demonstrate to its own regulators that the cross-institution governance decision was independently validated by the common regulatory authority node.

### FIG. 5D—Cross-Chain Bridge Adapters

FIG. 5D is a schematic diagram of the Cross-Chain Bridge Adapters executing within enclave-protected memory, collecting governance state data and executing authorization token delivery across Ethereum mainnet, Ethereum Layer 2 rollup networks, Avalanche, Polygon, Solana, Hyperledger Fabric, and R3 Corda, with each cross-chain data contribution cryptographically bound to the attestation report of the normalizing TEE instance and recorded in the Federated Provenance Ledger.

The cross-chain Enterprise Trust Federation Registry redundancy architecture is shown, depicting the registry smart contract deployed on multiple blockchain networks simultaneously—Ethereum mainnet for DeFi protocol integration, Hyperledger Fabric for permissioned institutional deployments, and Polygon for high-throughput enterprise operations—with all registry instances maintained in synchronized state through TEE-attested cross-chain update transactions.

The unified trust token delivery pathway across heterogeneous blockchain networks is depicted, showing how the Fabric produces a single unified trust token from the Cross-Cluster Attestation Bridge and delivers it to governance contracts on each applicable blockchain through attested bridge interfaces that verify TEE identity against the registry on the destination network before the governance contract processes the token, extending hardware-enforced cross-domain compliance to every blockchain on which any participating organization operates.

### FIG. 5E—Global Regulatory Jurisdiction Coverage

FIG. 5E is a schematic diagram illustrating the global regulatory jurisdiction coverage of the Unified Regulatory Verification Engine, showing the geographic scope of each jurisdiction-specific adapter and the corresponding Regulatory Verification Network node: SEC and CFTC adapters covering U.S. financial institutions, registered investment advisors, and commodity pool operators; FDA and CMS adapters covering U.S. healthcare AI and value-based care programs; MiCA adapters covering EU crypto-asset service providers under ESMA jurisdiction; Basel IV adapters covering systemically important financial institutions in all Basel Committee member jurisdictions; EMA adapters covering European adaptive licensing and clinical trial governance; ICH adapters covering international pharmaceutical development under Good Clinical Practice standards; and EU AI Act high-risk system adapters covering enterprises deploying AI in high-risk categories under the EU AI Act enforcement regime.

The single-computation multi-jurisdiction evidence property is depicted at global scale, showing how one cross-domain governance event—such as a cross-border capital allocation funding a clinical trial—produces one unified ZKP computation and one Federated Provenance Ledger Merkle commitment that simultaneously satisfies evidence requirements for all eight applicable regulatory frameworks, with Regulatory Verification Network nodes in each jurisdiction independently validating the same underlying Fabric state.

The global multi-enterprise federation reach is illustrated, showing that the Universal AI Governance Fabric is accessible to any organization worldwide that deploys a TEE-capable computing environment and publishes its enclave measurements to the Enterprise Trust Federation Registry, with the Fabric's hardware-anchored trust properties extending uniformly to every participating organization regardless of geographic jurisdiction, hardware vendor, cloud provider, or regulatory framework, making it the first AI governance platform capable of serving as a global mandatory-purchase compliance infrastructure for enterprises subject to overlapping multi-jurisdictional AI governance obligations.

### DETAILED DESCRIPTION OF THE INVENTION

The following description enables a person skilled in the art to make and use the invention. Plain-language notes in italics are provided at each major mechanism. The five improvements incorporated into this application—silicon root-of-trust anchoring, heterogeneous TEE orchestration, regulatory node architecture, hardware-synchronized atomic cross-domain transitions, and global multi-enterprise federation—are each addressed in dedicated subsections and woven throughout the claims.

### I. Silicon Root-of-Trust Anchor Layer

Referring to FIG. 1A, the Silicon Root-of-Trust Anchor Layer binds all Fabric attestation chains to vendor-specific silicon-level root keys that are embedded in each processor during manufacturing and cannot be extracted, copied, or modified by any software process at any privilege level. For Intel SGX instances, attestation chains terminate at the Intel root provisioning key verified through the Intel Provisioning Certification Service. For AMD SEV-SNP instances, attestation chains terminate at the Versioned Chip Endorsement Key burned into the AMD processor and verified through AMD's Key Distribution System. For ARM TrustZone instances, chains terminate at the Platform Security Architecture root keys embedded in the hardware Root of Trust for Reporting. For AWS Nitro instances, chains terminate at the Nitro Hardware Security Module root keys. For Azure Confidential Virtual Machines, chains terminate at the Trusted Platform Module 2.0 endorsement keys. For Google Cloud Confidential Computing, chains terminate at Google's hardware attestation root keys.

Plain language: Every trust claim in the Fabric traces back to a key physically burned into a chip at the factory. No software at any privilege level—not even the Fabric operator or the cloud provider—can fabricate this origin. This is the qualitative distinction between hardware-anchored governance and software governance.

The Silicon Root-of-Trust Anchor Layer verifies each domain TEE instance's attestation chain against its vendor's published root certificates before admitting the instance to the Cross-Cluster Attestation Bridge. This verification step closes the § 103 argument that software attestation systems already exist: software attestation systems use keys in software-accessible memory, while the present invention uses keys physically embedded in silicon that no software can touch. The combination of multi-vendor silicon roots with cross-cluster attestation bridging has not been taught or suggested by any prior art reference.

### II. Heterogeneous Tee Orchestration Layer

Referring to FIG. 1B, the Heterogeneous TEE Orchestration Layer simultaneously verifies, normalizes, and cross-verifies attestation reports from domain TEE instances spanning all seven supported hardware architectures. Provider-specific measurement fields—MRENCLAVE and MRSIGNER for Intel SGX; VCEK-signed SEV_SNP_REPORT for AMD SEV-SNP; TDREPORT for Intel TDX; PSA attestation tokens for ARM TrustZone; NSM attestation documents for AWS Nitro; VCEK-equivalent reports for Azure Confidential VMs; and TDX reports for Google Cloud—are each normalized to a unified internal representation by the Orchestration Layer's cross-vendor adaptation module before being presented to the Cross-Cluster Attestation Bridge for quorum verification.

Plain language: No cloud vendor can design around this patent by switching to a different enclave architecture, because the fabric covers all seven. A compromise of Intel SGX firmware is detected because the AMD and ARM instances still produce clean measurements. The quorum fails, the transition executes, and the fabric isolates the affected instances.

The quorum agreement threshold for the Heterogeneous TEE Orchestration Layer is configurable at deployment time to require agreement across a minimum number of distinct hardware vendors, preventing a scenario where quorum is technically achieved using only instances from a single vendor with a shared vulnerability. In preferred embodiments, quorum requires agreement from at least two distinct hardware vendors and at least three distinct TEE instances.

### III. Regulatory Node Architecture

Referring to FIG. 3D, the Regulatory Verification Network comprises independent verification nodes operated by regulators, designated auditors, and institutional counterparties. Each node receives Fabric evidence packs through a standardized attestation protocol interface, queries the Enterprise Trust Federation Registry to verify the enclave measurements of all contributing domain engines, verifies hardware monotonic counter sequences, confirms Federated Provenance Ledger Merkle commitment chains, and issues a cryptographically signed validation receipt. This architecture makes compliance independently verifiable rather than self-asserted—the most significant structural improvement over every prior compliance evidence system in regulated financial and healthcare markets.

Plain language: The SEC, FDA, EMA, and Basel IV supervisors each run their own verification software on their own servers. They check the evidence against the blockchain registry themselves. The Fabric cannot manipulate what they see or do not see. This is what compliance verification looks like when it is genuinely independent.

Regulatory Verification Network nodes operated by U.S. regulatory authorities validate against the Enterprise Trust Federation Registry on Ethereum mainnet and Hyperledger Fabric. EMA and ICH nodes validate against the same registries plus European permissioned ledger equivalents. Basel IV and FSB nodes validate against institutional ledger deployments. CMS and FDA nodes access jurisdiction-specific evidence pack adapters formatted according to CMS ACO shared savings documentation requirements and FDA Software as Medical Device guidance. Nodes operated by different regulators may independently verify the same governance event without coordination with each other, because all validation relies on the same on-chain registry and the same Federated Provenance Ledger Merkle commitments that each node independently accesses.

### IV. Atomic Cross-Domain State Transition Mechanism

Referring to FIG. 4, upon detection of a threshold violation in any bridged domain confirmed by multi-TEE quorum, the Atomic Cross-Domain Transition Orchestrator executes four steps simultaneously across all participating domain TEE instances of all bridged organizations. No step completes before all steps complete—the operation is atomic by construction, with no exploitable partial intermediate state at any software privilege level including blockchain validators, relayer nodes, and cloud provider management planes.

Step 1—Cross-Domain Record: A cross-domain state-transition record is incorporated into the attestation report user-data field of every bridged TEE instance across all domains simultaneously, binding the violation to hardware-signed attestation in every participating domain. See FIG. 4B.

Step 2—Simultaneous Re-key: Baseline session keys are atomically zeroed from enclave-protected memory across all domain TEE instances of all participating organizations simultaneously—permanently unrecoverable at any privilege level—while post-transition session keys are derived within each instance via CRYSTALS-Kyber key derivation from its degraded-state attestation. See FIG. 4C.

Step 3—Synchronized Count: Hardware monotonic counters increment across all participating instances of all bridged domains and all participating organizations simultaneously, advancing to the next expected value with cross-vendor consistency verification, providing tamper-resistant temporal ordering of the cross-domain violation event. See FIG. 4D.

Step 4—Multi-Organization Isolate: IOMMU-enforced network isolation activates simultaneously across all participating domain TEE instances of all organizations, independently of software-layer access controls, maintained until the Multi-Domain State Synchronization Machine confirms threshold restoration across all instances of all organizations through synchronized quorum re-evaluation. See FIG. 4D.

Three independent mechanisms enforce cross-domain cryptographic irreversibility. Simultaneous baseline key destruction across all domain instances and all organizations eliminates the material for pre-transition tokens and proofs across the entire fabric at the silicon level. Binding cross-domain state-transition records to hardware-signed attestation in every participating domain creates externally verifiable evidence that cannot be forged without simultaneously compromising the hardware root-of-trust elements of every participating instance across every vendor. Synchronized hardware monotonic counter increment prevents cross-domain event sequence rollback at any software privilege level. Post-quantum key derivation ensures all three irreversibility properties persist against quantum computing adversaries.

### V. Global Enterprise Federation Architecture

Referring to FIG. 5C and FIG. 5E, the Global Enterprise Federation Architecture enables independent organizations—each operating their own domain-specific TEE instances—to participate in a shared Universal AI Governance Fabric while maintaining hardware-level isolation of their proprietary data. Each participating organization publishes its domain TEE enclave measurements to the shared Enterprise Trust Federation Registry through TEE-attested multi-signature authorization transactions, receiving in return the ability to generate and receive unified trust tokens that are verifiable by any other organization in the federation and by any Regulatory Verification Network node worldwide.

Plain language: A hospital in Boston, a bank in Frankfurt, and a pharmaceutical consortium in Singapore can each operate their own domain TEE instances on their own hardware and in their own cloud environments. They share nothing except the blockchain registry and the unified Fabric protocol. Their proprietary data never crosses organizational boundaries. Yet a regulator in any jurisdiction can independently verify that their cross-organizational governance decision was compliant.

The multi-enterprise federation architecture extends hardware-enforced compliance across organizational boundaries without requiring any organization to trust another organization's software or administrative controls. The trust relationship is mediated entirely by the Enterprise Trust Federation Registry—which records only enclave measurements, not data—and by the unified cryptographic governance state produced by the Fabric from the hardware-signed attestation reports of all participating instances. No organization can manipulate another organization's governance decision, and no organization can claim compliance on behalf of another, because the ZKP circuit requires hardware-signed attestation inputs from all contributing domain instances to produce a valid unified proof.

### VI. Preferred Embodiment—Cross-Domain Capital Allocation for Regenerative Medicine

A U.S. hospital network, a Basel IV-regulated investment bank, and a European regenerative-medicine consortium deploy the Fabric as a multi-enterprise SaaS federation. Each organization spins up domain TEE instances—the hospital on AWS Nitro Enclaves for clinical AI, the bank on Azure Confidential VMs with AMD SEV-SNP for financial compliance, the consortium on Google Cloud Confidential Computing with Intel TDX for EMA-regulated clinical data—and publishes enclave measurements to the Enterprise Trust Federation Registry on Ethereum mainnet and Hyperledger Fabric.

Step 1—Proposal Submission: A capital allocation proposal to fund a stem-cell trial at a European consortium site is submitted by the bank's governance system. The Cross-Cluster Attestation Bridge ingests the bank's Basel IV attestation, the hospital's clinical safety attestation, and the consortium's EMA compliance attestation through the Heterogeneous TEE Orchestration Layer.

Step 2—Cross-Domain Risk Assessment: The Multi-Domain State Synchronization Machine runs the domain-agnostic ZKP circuit with public inputs from all three domain instances. All thresholds pass: the Basel IV LCR is at 131%, the clinical safety model is in compliant state, and the consortium's EMA adaptive licensing evidence is current. Quorum is established across seven TEE instances spanning three hardware vendors.

Step 3—Unified Evidence Generation: The Unified Regulatory Verification Engine produces six simultaneous evidence packs: SEC Form PF (bank's investment advisor obligations), Basel IV Pillar III (bank's capital disclosure), CMS value-based care documentation (hospital's outcomes reporting), EMA adaptive licensing evidence (consortium's clinical trial governance), MiCA governance documentation (cross-border token transfer), and ICH Good Clinical Practice (trial protocol compliance). Regulatory Verification Network nodes operated by the SEC, EMA, and the bank's Basel IV supervisor each independently validate and issue signed receipts.

Step 4—Swarm Execution: The Autonomous Agent Swarm Governance Coordinator issues hardware-attested agent authorization tokens to a coalition of 47 AI agents—12 capital routing agents, 19 clinical protocol agents, and 16 regulatory reporting agents—all operating under the unified fabric compliant-state session key. The entire cross-domain governance event executes in under 400 milliseconds with full cryptographic non-repudiation.

Step 5—Ledger Recording: All governance events are recorded in the Federated Provenance Ledger Aggregator with synchronized monotonic counter values and post-quantum CRYSTALS-Dilithium signatures on Merkle root exports, completing the silicon-to-regulator audit trail.

### VII. Five Technical Properties Impossible in Software-Only Systems

Property 1—Silicon-Origin Cryptographic Irreversibility. Simultaneous forced re-keying with post-quantum key derivation destroys all baseline session keys across all domain instances of all participating organizations at the silicon level the moment a threshold violation is confirmed by cross-domain quorum. No software-only system can provide this because software key stores reside in memory accessible to processes capable of copying key material before destruction completes across all instances simultaneously.

Property 2—Multi-Vendor Hardware-Rooted Temporal Ordering. Synchronized silicon-bound hardware monotonic counters across all participating instances spanning multiple hardware vendors provide tamper-resistant ordering of all cross-domain governance events. Cross-vendor counter synchronization means a single-vendor compromise cannot reorder events—the multi-vendor quorum detects the counter discrepancy and rejects the non-matching attestation.

Property 3—Regulator-Operated Third-Party Verification. Fabric evidence packs independently validated by regulator-operated Regulatory Verification Network nodes—not by the governed system—create governance compliance evidence that cannot be forged, disputed, or manipulated between generation and regulatory review. No prior AI governance compliance evidence system provides this property.

Property 4—Multi-Domain Privacy-Preserving Regulatory Verifiability. Domain-agnostic ZKP circuits allow eight regulatory frameworks to simultaneously verify full cross-domain governance compliance without accessing proprietary model parameters, patient records, financial positions, or influence data from any participating domain or organization. This enables regulatory supervision across multi-enterprise federations without requiring any participant to reveal proprietary or privacy-protected information to any other participant or regulator.

Property 5—Global Multi-Vendor Multi-Enterprise Hardware Defense. All cross-domain governance logic executes within silicon-level enclave-protected memory using constant-time execution paths preventing timing side-channel attacks; multi-vendor multi-TEE quorum preventing single-vendor compromise; an on-chain Enterprise Trust Federation Registry preventing counterfeit Fabric deployment; post-quantum signatures protecting the complete attestation chain; IOMMU-enforced network isolation at the hardware level across all organizations simultaneously; and independent regulator-operated validation nodes. These six defense layers constitute a technical improvement to multi-enterprise AI governance computer systems impossible to achieve in software-only implementations, satisfying 35 U.S.C. § 101 under the 2025 Kim Memorandum and December 2025 Desjardins guidance.

What is claimed is:

1. A hardware-anchored Universal AI Governance Fabric for cross-domain AI governance at enterprise and multi-enterprise scale, comprising:
one or more processors operating within enclave-protected memory pages establishing a Silicon Root-of-Trust Anchor Layer that binds all Fabric attestation chains to vendor-specific silicon-level root keys selected from Intel SGX root provisioning keys, AMD SEV-SNP Versioned Chip Endorsement Keys burned into the processor during manufacturing, ARM TrustZone Platform Security Architecture root keys embedded in the hardware Root of Trust for Reporting, AWS Nitro Enclave Hardware Security Module root keys, Azure Trusted Platform Module 2.0 endorsement keys, and Google Cloud hardware attestation root keys, wherein all attestation chain verification is performed against the published root certificates of the respective hardware vendor and no silicon root key is accessible to any software process at any privilege level;
a Heterogeneous TEE Orchestration Layer that simultaneously enrolls, verifies, normalizes, and cross-verifies attestation reports from domain-specific TEE instances spanning at least two distinct hardware architectures selected from Intel SGX, AMD SEV-SNP, Intel TDX, ARM TrustZone, AWS Nitro Enclaves, Azure Confidential Virtual Machines, and Google Cloud Confidential Computing, normalizing provider-specific measurement fields to a unified internal representation, and executing cross-vendor measurement verification with multi-TEE quorum requiring agreement across a threshold of instances spanning at least two distinct hardware vendors;
a Cross-Cluster Attestation Bridge executing within enclave-protected memory that receives hardware-signed attestation reports from at least two domain-specific TEE engines representing at least two distinct commercial AI governance domains, normalizes provider-specific report formats, cross-verifies enclave measurements against an Enterprise Trust Federation Registry, verifies hardware monotonic counter consistency, and produces unified trust tokens carrying attestation signatures from all contributing domain instances with registry measurement hashes embedded for on-chain verification;
the Enterprise Trust Federation Registry comprising a smart contract deployed on at least one blockchain network or permissioned distributed ledger storing approved static enclave measurements for all participating domain-specific TEE engines and for the Fabric orchestration layer, queried by the Cross-Cluster Attestation Bridge and by all domain governance contracts before accepting cross-cluster trust tokens, wherein registry updates require TEE-attested multi-signature quorum authorization and tokens from engines with non-matching measurements are structurally rejected;
a Regulatory Verification Network comprising independent verification nodes operated by at least one entity selected from a regulatory authority, designated auditor, or institutional counterparty, wherein each node autonomously validates Fabric evidence packs by querying the Enterprise Trust Federation Registry to verify enclave measurements of all contributing domain engines, verifying hardware monotonic counter sequences for temporal consistency across all bridged instances, confirming Federated Provenance Ledger Merkle commitment chains, and verifying post-quantum signatures on all attestation exports, and issues signed validation receipts embedded in final compliance evidence packages;
a Unified Regulatory Verification Engine that produces, from a single domain-agnostic zero-knowledge proof computation over a unified arithmetic circuit whose public inputs comprise attestation report user-data fields, Federated Provenance Ledger Merkle roots, hardware monotonic counter values, and multi-instance quorum confirmation signatures, and whose private inputs comprise all domain-specific model parameters and sensitive data that are never revealed in proof outputs, simultaneous jurisdiction-specific compliance evidence packages for at least six regulatory frameworks selected from SEC, CFTC, MiCA, Basel IV, FDA, CMS, EMA, ICH, FCA, FSB, or EU AI Act, wherein evidence package export is structurally gated on Regulatory Verification Network node validation receipts from all applicable jurisdiction nodes;
a Multi-Domain State Synchronization Machine that monitors compliance threshold status across all bridged domain engines and, upon detection of a threshold violation in any domain confirmed by multi-TEE quorum, triggers an Atomic Cross-Domain Transition Orchestrator that simultaneously executes, across all participating domain TEE instances of all bridged organizations as a single atomic operation with no partial intermediate states: incorporating a cross-domain state-transition record into the attestation report user-data field of every bridged instance; atomically destroying all baseline session keys and deriving post-transition session keys via post-quantum CRYSTALS-Kyber key derivation from degraded-state attestations within each respective TEE; incrementing hardware monotonic counters across all instances; and activating IOMMU-enforced network isolation across all instances independently of operating system or hypervisor access controls;
a Federated Provenance Ledger Aggregator comprising an append-only SHA-3 Merkle tree executing within enclave-protected memory that merges domain-specific SHA3-256 hash-chained ledger entries from all participating domain TEE instances into a single unified Merkle root commitment signed with post-quantum CRYSTALS-Dilithium or SPHINCS+ signatures, providing a single cryptographically verifiable source of truth for all AI governance decisions across all domains and all participating organizations;
a Post-Quantum Multi-Domain Attestation Layer applying post-quantum cryptographic algorithms selected from CRYSTALS-Dilithium, Falcon, or SPHINCS+ to all attestation report exports and Federated Provenance Ledger Merkle root exports, and applying CRYSTALS-Kyber key encapsulation to all inter-TEE communications within the Heterogeneous TEE Orchestration Layer and Cross-Cluster Attestation Bridge, ensuring cryptographic security of the cross-domain compliance evidence pipeline against quantum computing attacks across multi-decade regulatory retention periods; and
an Autonomous Agent Swarm Governance Coordinator that orchestrates coalitions of AI agent instances spanning at least two commercial domains under the unified Fabric compliant-state session key, issuing hardware-attested agent authorization tokens, revoking all agent authorizations simultaneously when the Multi-Domain State Synchronization Machine executes a cross-domain transition, and recording all agent authorization and revocation events in the Federated Provenance Ledger with monotonic counter values and multi-instance attestation signatures.

2. A computer-implemented method for hardware-anchored cross-domain AI governance at enterprise and multi-enterprise scale, comprising:
binding all attestation chains to vendor-specific silicon-level root keys through a Silicon Root-of-Trust Anchor Layer, verifying each domain TEE instance attestation chain against the published root certificate of the respective hardware vendor, and admitting only silicon-root-verified instances to cross-domain governance operations;
simultaneously enrolling, verifying, normalizing, and cross-verifying attestation reports from domain-specific TEE instances spanning at least two distinct hardware architectures through a Heterogeneous TEE Orchestration Layer, establishing multi-vendor multi-TEE quorum requiring agreement across instances spanning at least two distinct hardware vendors before any cross-cluster trust token is generated;
federating at least two domain-specific TEE engines representing at least two distinct commercial AI governance domains through a Cross-Cluster Attestation Bridge, cross-verifying enclave measurements against an Enterprise Trust Federation Registry on at least one blockchain network or permissioned distributed ledger, and producing unified trust tokens carrying attestation signatures from all contributing domain instances;
upon detection of a threshold violation in any bridged domain confirmed by multi-vendor multi-TEE quorum, executing simultaneously across all participating domain TEE instances of all bridged organizations as a single atomic operation: incorporating cross-domain state-transition records into all bridged attestation user-data fields; atomically destroying all baseline session keys and deriving post-transition session keys via CRYSTALS-Kyber within each respective TEE; incrementing hardware monotonic counters across all instances; and activating IOMMU-enforced network isolation across all instances;
aggregating domain-specific SHA3-256 hash-chained provenance ledger entries from all participating domain instances into a single Federated Provenance Ledger Merkle root commitment signed with post-quantum signatures; and
generating, from a single domain-agnostic zero-knowledge proof computation, simultaneous jurisdiction-specific compliance evidence packages for at least six regulatory frameworks, gated on Regulatory Verification Network node validation receipts from independent nodes operated by at least one regulatory authority, designated auditor, or institutional counterparty.

3. One or more non-transitory computer-readable media storing instructions that, when executed by processors operating within Trusted Execution Environments across at least two distinct hardware architectures, cause the processors to perform:
establishing a Silicon Root-of-Trust Anchor Layer binding attestation chains to vendor-specific silicon-level root keys, publishing enclave measurements to an Enterprise Trust Federation Registry through TEE-attested multi-signature authorization, and participating in Heterogeneous TEE Orchestration with multi-vendor quorum verification;
receiving hardware-signed attestation reports from at least two domain-specific TEE engines through a Cross-Cluster Attestation Bridge, cross-verifying enclave measurements, verifying hardware monotonic counter consistency, and producing unified trust tokens;
upon detection of a threshold violation confirmed by multi-vendor quorum, executing the complete four-step atomic cross-domain transition—cross-domain state-transition record incorporation, simultaneous baseline session key destruction with post-quantum re-keying, hardware monotonic counter increment, and IOMMU-enforced network isolation—simultaneously across all participating instances as a single atomic operation;
aggregating domain-specific provenance ledger entries into a single Federated Provenance Ledger Merkle root with post-quantum signatures, providing signed attestation reports and Merkle commitments to independent Regulatory Verification Network nodes for validation; and
generating simultaneous multi-jurisdiction compliance evidence from a single domain-agnostic ZKP computation, gated on Regulatory Verification Network validation receipts, formatted for at least six regulatory frameworks.

4. The system of claim 1, wherein the Silicon Root-of-Trust Anchor Layer verifies attestation chains for each participating domain TEE instance against its vendor's published root certificates before admitting the instance to the Cross-Cluster Attestation Bridge, and wherein any instance whose attestation chain fails silicon root verification is structurally excluded from cross-domain governance operations without requiring administrator intervention.

5. The system of claim 1, wherein the Heterogeneous TEE Orchestration Layer's quorum requirement is configurable to mandate agreement from instances spanning at least two distinct hardware vendors, preventing single-vendor-compromise scenarios from achieving quorum, and wherein the quorum threshold is sealed in enclave-protected memory at initialization and inaccessible to all external processes.

6. The system of claim 1, wherein the Regulatory Verification Network nodes are operated by at least two entities selected from a national regulatory authority, designated independent auditor, or institutional counterparty, and wherein each node independently queries the Enterprise Trust Federation Registry to verify enclave measurements of all contributing domain engines before issuing any validation receipt, creating an independently verifiable chain from silicon root key through regulatory compliance confirmation for every cross-domain governance event.

7. The system of claim 1, wherein the Atomic Cross-Domain Transition Orchestrator executes the four-step atomic transition within a guaranteed maximum latency of five hundred milliseconds across all participating domain TEE instances of all bridged organizations, measured from quorum confirmation of threshold violation to completion of IOMMU isolation across all instances, providing real-time cross-domain enforcement compatible with high-frequency financial and clinical governance operations.

8. The system of claim 1, wherein the Enterprise Trust Federation Registry smart contract is deployed on at least two distinct blockchain networks for redundancy, and wherein governance contracts on each target network independently query the registry instance on their own network before accepting any unified trust token, extending registry-based hardware measurement verification to every blockchain on which any participating organization operates.

9. The system of claim 1, wherein the Post-Quantum Multi-Domain Attestation Layer applies CRYSTALS-Dilithium signatures providing security against Shor's algorithm attacks on classical signature schemes to all unified trust tokens and Federated Provenance Ledger Merkle root exports, ensuring compliance evidence submitted to regulatory portals remains verifiable across the multi-decade retention periods required by SEC Rule 17a-4, FDA 21 CFR Part 11, EMA clinical trial record retention obligations, and MiCA governance documentation requirements.

10. The system of claim 1, wherein the Autonomous Agent Swarm Governance Coordinator supports swarms of at least one hundred AI agent instances spanning at least three distinct commercial domains, wherein agent authorization tokens carry the unified trust token commitment and the synchronized hardware monotonic counter value at issuance, and wherein token revocation propagates to all swarm members simultaneously through post-quantum authenticated broadcast messages within five hundred milliseconds of a cross-domain transition.

11. The system of claim 1, wherein the Federated Provenance Ledger Aggregator employs SHA3-256 for individual domain ledger entry hashing and SHA3-512 for unified Merkle root computation, with CRYSTALS-Dilithium or SPHINCS+ post-quantum signatures applied to all Merkle root exports transmitted to Regulatory Verification Network nodes and embedded in compliance evidence packages.

12. The method of claim 2, wherein generating simultaneous jurisdiction-specific compliance evidence packages comprises simultaneously formatting evidence for at least eight frameworks including SEC Form PF, Form ADV, and Schedule D; CFTC Regulation 4.22 and NFA compliance; MiCA ESMA Articles 68 through 76; Basel IV EBA and BCBS Pillar III; FDA Software as Medical Device and RMAT; CMS value-based care and ACO shared savings; EMA adaptive licensing; and ICH Good Clinical Practice, all from one ZKP computation and one Federated Provenance Ledger Merkle commitment.

13. The system of claim 1, wherein reversion to the baseline compliant state requires complete reinitialization of the entire Fabric—destroying all session keys across all domain TEE instances of all participating organizations, resetting all attestation states, re-publishing updated enclave measurements to the Enterprise Trust Federation Registry through new TEE-attested multi-signature update transactions requiring quorum from all reinitializing instances, and confirming updated measurements on all supported blockchain networks making risk-degraded state reversion cryptographically irreversible without complete fabric restart.

14. The system of claim 1, wherein the domain-agnostic zero-knowledge proof circuit employs Groth16 proof constructions producing constant-size proofs for sub-millisecond regulatory portal verification in preferred embodiments, or STARK-based constructions providing full post-quantum resistance through exclusive reliance on SHA-3 hash function collision hardness without trusted setup in alternative embodiments, with proof construction configurable per deployment and per jurisdiction.

15. The system of claim 1, wherein the multi-enterprise federation architecture enables at least three independent organizations to each operate domain-specific TEE instances contributing to the shared Fabric while maintaining hardware-level isolation of proprietary data within their respective domain TEE instances, with inter-organizational trust mediated exclusively through the Enterprise Trust Federation Registry and the unified cryptographic governance state produced from hardware-signed attestation reports, requiring no organization to expose proprietary data, model parameters, or administrative access to any other organization.

16. The system of claim 1, wherein the Cross-Cluster Attestation Bridge supports federated learning gradient aggregation sealed within the Fabric, wherein gradient updates from domain AI models are aggregated inside enclave-protected memory using Secure Aggregation protocols, the aggregated gradient is bound to the Fabric's unified trust token, and the resulting model update is attested as having been produced under the hardware-anchored governance state without revealing individual domain model gradients to any other domain or to the Fabric operator.

17. The system of claim 1, wherein the Unified Regulatory Verification Engine includes jurisdiction-specific adapters that map attested cross-domain governance outcomes to CMS ACO shared savings evidence, EMA adaptive licensing documentation, and Basel IV Pillar III disclosures from a single ZKP computation, with each adapter's output verified by the corresponding Regulatory Verification Network node before evidence pack finalization.

18. The method of claim 2, further comprising activating automated treasury and clinical safeguards concurrently with any cross-domain threshold breach, wherein treasury freezes, graduated circuit-breaker withdrawal limits, and insurance pool funding triggers for financial domain participants, and clinical hold triggers and robotic administration suspension for clinical domain participants, are all enforced through the post-transition session key gating inside the respective domain TEEs simultaneously with the cross-domain atomic transition, making all safeguards non-bypassable by any governance vote, administrative action, or software process in any domain.

19. The system of claim 1, wherein the Fabric operates a Global Enterprise Federation in which participating organizations in any geographic jurisdiction deploy domain-specific TEE instances—using any supported hardware architecture and any supported cloud provider—contribute to the shared Enterprise Trust Federation Registry, and receive access to Regulatory Verification Network validation nodes corresponding to their applicable regulatory frameworks, with the Fabric's hardware-anchored trust properties extending uniformly to every participating organization regardless of jurisdiction, hardware vendor, or cloud provider.

20. The system of claim 1, wherein the Fabric enforces a unified cryptographic governance state across all six commercial domains of the Bickerstaff portfolio simultaneously—Influence and Trust, Clinical AI and Healthcare, AI Governance and Autonomous Agents, Financial AI and Capital Markets, Decentralized Governance, and Quantum-Safe and Frontier Technology—producing a single Federated Provenance Ledger Merkle root that commits to governance decisions across all six domains and a single ZKP proof that simultaneously demonstrates compliance across all applicable regulatory frameworks, constituting the first platform capable of governing multi-domain AI agent swarms with regulator-verifiable, non-repudiable, quantum-resistant evidence that is architecturally impossible to forge, bypass, or manipulate by any software process, privileged operator, voting majority, or cloud provider.
